(19) United States
(12) Patent Application Publication
(10) Pub. No.: US 2004/0199650 A1
(43) Pub. Date: Oct. 7, 2004

(54) System and methods for accelerating data delivery

(76) Inventors: John E. Howe, Saratoga, CA (US); Satish N. Menon, Mountain View, CA (US); Jayakumar Muthukumarasamy, Dublin, CA (US); Alberto Nava, Burlingame, CA (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/713,656

(22) Filed: Nov. 14, 2003

Related U.S. Application Data
(60) Provisional application No. 60/426,507, filed on Nov. 14, 2002.

(51) Int. Cl. G06F 15/16

(52) U.S. Cl. 709/230

(57) ABSTRACT

Embodiments of the present invention provide for sending data over a generic network interface in such a way that the resources used by the host CPU for packetization is minimized, allowing more packets to be sent across the network than is currently possible using existing technologies. Data is sent in a timely manner, minimizing jitter associated with real-time data delivery, especially for multimedia applications. CPU resource utilization is achieved by using a number of different techniques, such as zero-copy data movement where the data from a storage system is made available directly to the network driver without creating intermediate copies that consume CPU resources to do the copying.

### RELATED APPLICATIONS

The present application claims the benefit of the filing date of U.S. Provisional Application Serial No. 60/426,507, filed 14 November, 2002, which application is hereby incorporated by reference.

### TECHNICAL FIELD

The present invention relates to communication over a network, and more particularly, to accelerating real-time or multimedia data delivery.

### BACKGROUND OF THE INVENTION

In real-time applications—such as those involving video, audio, or gaming media files—end users are sensitive to the rate at which data is received. Large amounts of data must be sent over a network in many real-time applications such that the playback or presentation of that data can occur in a timely, and unbroken, fashion. Accordingly, it is desirable to lower the central processing unit (CPU) usage requirements per network interface such that a host or server application can send more data to a network with higher throughput while minimizing the amount of CPU cycles used. Several aspects of network communication consume CPU cycles.

One aspect of network communication consuming CPU time is writing data to a network protocol stack. When a computer writes data to a network, the data goes through a network protocol stack in the operating system of the computer. For example, a typical network protocol stack 10 is shown in FIG. 1. The network protocol stack 10 typically supports several protocols—a Transmission Control Protocol (TCP) 20 and a User Datagram Protocol (UDP) 15. The network stack 10 is typically presented to an application running on a computer through a socket interface 25. To write data to a network, the application opens the socket interface 25 that represents the end point and after successfully opening and initializing the socket, writes data to the socket interface 25. The data goes through the network protocol stack 10, is modified appropriately (such as addition of protocol headers or breaking down into smaller segments or packets) and is finally passed on to a driver representing a network interface controller (NIC) hardware. The NIC finally sends the data over the network.

In typical packet-switched networks, there is a limit on how big each individual packets can be (usually called the Maximum Transmission Unit or MTU). This limit is determined by the protocol layer with which the user program communicates. For example, a socket that represents the UDP protocol stack has a packet limit of 65536 bytes where as at the NIC driver level, Ethernet packets are typically limited to 1536 bytes in size. So, for example, when writing UDP data, the written data gets split into multiple UDP packets and multiple ethernet packets and before getting sent over the network. On the receiving side, these packets need to be reassembled to obtain the original packet. Streaming applications have their own limits for packet sizes (e.g. when using a Gige QAM, the packet sizes are restricted to 188, 376, 564, 752, 940, 1128, 1316). If the application needs to send data in these packet sizes to the network, it needs to issue multiple calls to the network stack and write each packet individually. Hence, it takes multiple calls to send data over the network.

In the network stack 10 shown in FIG. 1 there is a one-to-one relationship between the calls an application makes to the socket 10 and the packets written out to a network. That is, the application must write the data one packet-size at a time to the socket 25. Accordingly, it takes multiple calls to send data larger than a packet size. Each call consumes CPU resources. For example, every call is typically implemented as a context switch—where one process stops execution on a central processing unit (CPU), records its state, and another process starts. This process results in inefficiencies in sending large amounts of data that need to be written to the network stack one packet at a time. The problem becomes particularly acute when dealing with larger amounts of data, and even more acute when that data needs to be delivered in a rapid or time-sensitive fashion (for example, audio and video streaming). More and more CPU cycles are required to process and provision the network packets.

One attempted solution to this problem has been to increase the allowable packet size. Accordingly, larger amounts of data may be written to the socket at one time. This solution, however, requires changing the firmware on the networking hardware throughout the network to recognize the larger packet size, and is therefore expensive and often not practical.

Other attempted solutions involve performing TCP processing on custom network interface controllers. These solutions are again expensive, as they require changes in low-level network controllers. Further, offloading the TCP processing is ineffective at solving the audio or video streaming problems, as media streaming applications often do not use the TCP protocol.

Another inefficiency in the use of CPU time in sending data over a network arises from when an application writes data to the socket 25 as it access the network stack 10. During the write, a memory copy is performed from application buffers to network buffers. This memory copying results in further inefficiencies.

One partial solution has been to increase the efficiency of the network stack by moving it outside of the operating system kernel. Accordingly, applications are given direct access to their own “virtual interface”, allowing them to send and receive packets without operating system interaction. However, this solution does not address the needs of streaming media in a time-sensitive, or real-time, environment where users are sensitive to jitter—or the variability of packet delays. In real-time systems—such as audio and/or video streaming, jitter is often intolerable by an end user. The network buffers are also required to be registered with the network interface controller, further, this scheme requires the sender and receiver to co-operate in managing the buffers, resulting in expensive and impractical firmware changes if the network buffers are changed. Several operating systems try to do zero-copy writes from the user level buffers directly. But, this often doesn't provide the desired performance improvement because the application needs to obey alignment and length restrictions to obtain these benefits. This is often not possible in streaming media applications.

There is therefore a need for a system and method to improve the efficiency of real-time data delivery over standard network interfaces. in such a way that the resultant system and method would minimize the jitter of packets and be suitable for delivery of time-sensitive data to clients. Such a system and method would preferably minimize the jitter of packets over the network.

### SUMMARY OF THE INVENTION

In accordance with one aspect of the present invention, a method for reducing processor cycles required to send data over a communication link in packets having a packet size is provided. A write call is sent to a driver through a socket comprising a destination and a quantity of data greater than said packet size. A zero-copy write of said quantity of data to said driver is performed. A plurality of packets, less than or equal to said packet size, are generated.

In accordance with another aspect of the present invention, a method for reducing buffering requirements on a network switch is provided. A write call is received from an application through a socket, the write call including a plurality of destinations, including a first destination and a second destination, and a first quantity of data destined for the first destination, and a second quantity of data destined for the second destination. The first quantity of data is packetized into a plurality of packets less than or equal to a packet size, each packet destined for the first destination. At least one packet is generated including at least a portion of the second quantity of data destined for the second destination. A first packet is transmitted to the network switch destined for the first destination. At least one packet destined for the second destination is then transmitted to the network switch, before transmitting a second packet destined for the first destination.

In accordance with another aspect of the present invention, a system for sending data across a network is provided. A computer is provided running an application configured to send a write call to a driver through a socket, the write call including a destination and a quantity of data greater than a packet size, the driver configured to packetize said data into a plurality of packets less than or equal to said packet size. A downstream device is in communication with the computer and configured to receive at least one of said packets.

### BRIEF DESCRIPTION OF THE DRAWINGS

FIG. 1 depicts a standard network stack according to the prior art.

FIG. 2 depicts a driver according to an embodiment of the present invention.

FIG. 3 depicts a write call, according to an embodiment of the present invention.

FIG. 4 depicts a system according to an embodiment of the present invention.

### DETAILED DESCRIPTION OF PREFERRED EMBODIMENTS

Embodiments of the present invention provide for sending data over a generic network interface in such a way that the resources used by the host CPU for packetization is minimized, allowing more packets to be sent across the network than is currently possible using existing technologies. Data is sent in a timely manner, minimizing jitter associated with real-time data delivery, especially for multimedia applications. CPU resource utilization is achieved by using a number of different techniques, such as zero-copy data movement where the data from a storage system is made available directly to the network driver without creating intermediate copies that consume CPU resources to do the copying.

Embodiments of the present invention find use with real-time applications. By real-time, time-based, time-sensitive, or streaming herein is generally meant communication to a user, program, or device having timing requirements for the arrival of the data. Generally, the data is intended for continuous presentation to an end user and some of the data begins being presented prior to the arrival of the complete file or data set. The remainder of the data must then be delivered to the end user in a timely fashion such that unacceptable discontinuities or jitter are minimized. While embodiments of the present invention are advantageously implemented with real-time data or real-time applications, substantially any data—including non-real-time or non-time-sensitive data—may be manipulated and communicated with embodiments of methods and systems of the present invention.

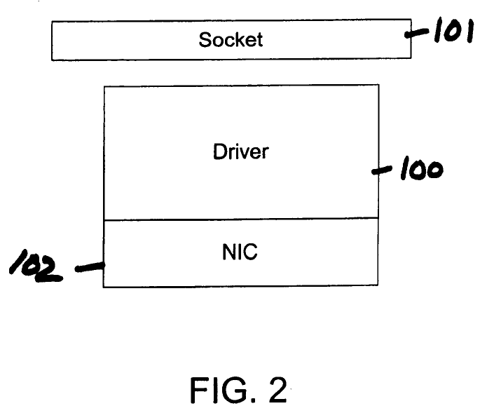

Embodiments of the present invention provide a driver 100 configured to reduce the CPU cycles required to write data to a network. The driver 100 is configured to receive a write call from an application through a socket 101, as shown in the embodiment in FIG. 2. Any application may make use of the driver 100. Preferred applications in embodiments of the invention include multimedia applications such as streaming media (audio, video, games, etc.). Accordingly, applications broadcasting live or prerecorded video or audio, such as RealNetworks'® broadcasters and the like, may be used. Audio on demand applications may utilize driver 100, such as RealPlayer®, NetShow®, and Inter Wave. Video on demand applications may utilize driver 100, such as RealPlayer® and the like. Internet telephony applications may utilize the driver 100, in some embodiments. Videoconferencing applications, such as CU-SeeMe®, may also utilize the driver 100, in some embodiments.

The write call includes a destination and data to be sent to the destination. In some embodiments, the write call includes a plurality of destinations and data to be sent to each of the destinations. The write call may include a larger quantity of data than the packet size used in a network. The driver generates packets of the appropriate packet size to communicate with a network interface controller 102 and send over a network. In accordance with embodiments of the invention, the packets generated by the driver 100 may be generated according to any of a variety of protocols as known in the art—including, for example TCP and UDP packets.

The driver 100 is preferably implemented in software. In accordance with embodiments of the invention, substantially any programming language may be used to implement the driver 100. In accordance with embodiments of the invention, the driver 100 is implemented as a module of an operating system. The driver 100 may be a module of any known operating systems, including for example, any version of the Microsoft Windows operating system (including but not limited to the Microsoft Longhorn operating system), Linux, UNIX, Macintosh operating systems, and the like. In other embodiments, the driver 100 may be implemented as hardware, firmware, software, or any combination thereof.

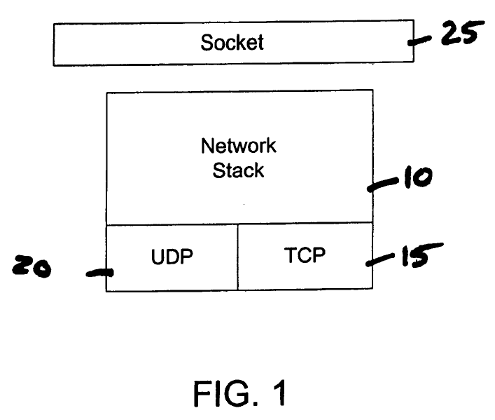

In some embodiments the driver 100 as shown in FIG. 2 is operable alongside the standard network protocol stack shown in FIG. 1. That is, in some embodiments, an application could access either the standard network stack, the driver 100, or both. Accordingly, in some embodiments, data having more relaxed timing demands (such as web pages, text, control messages, and the like in some embodiments), is communicated to the standard network stack, while data for real-time or streaming applications is sent to the driver 100. In some embodiments, all UDP data is sent to the driver 100, while data using other protocols is sent to the standard network stack.

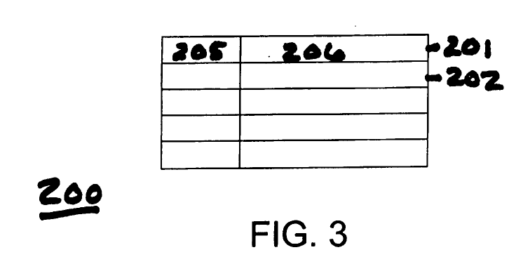

An embodiment of a write call 200 according to the present invention is shown in FIG. 3. The write call 200, in the embodiment shown in FIG. 3 is formatted as a write vector, including a plurality of entries, such as an entry 201 and an entry 202. In other embodiments, other formats for the write call 200 may be used. In the embodiment shown in FIG. 3, each entry includes a destination and data to be sent to that destination. For example, the entry 201 includes destination 205 and data 206 to be sent to the destination 205. The write call 200 shown in FIG. 2 includes five entries. Accordingly, the write call 200 shown in FIG. 2 may include up to five destinations. In some embodiments, one or more entries have the same destination. In some embodiments, fewer or greater than five entries are included in a write call—including 1, 2, 3, 4, 5, 6, 7, 8, 9, 10, 11, 12, 13, 14, 15, 16, 17, 18, 19, and 20 entries. In some embodiments, greater than 20 entries are included in a write call. In some embodiments, the same quantity of data is provided in each entry, in other embodiments different quantities of data are provided in different entries. In some embodiments, a write call includes at least one entry having a quantity of data greater than a packet size. In some embodiments, a write call includes at least one entry having a quantity of data less than a packet size. In some embodiments, a write call includes at least one entry having a quantity of data equal to a packet size.

Data included in the write call may include any data to be transmitted over a network, in accordance with embodiments of the invention. Preferred data include all or portions of a multimedia file such as audio, video or game media files. Preferred media files include, but are not limited to, live or prerecorded radio or television broadcasts, audio files, archival recordings, lectures, movies, movie clips, television shows, documentaries, sporting events, theatrical performances, concerts, cartoons, music videos and music video clips, local and long distance telephone calls, video conference images and sound, games and the like.

Accordingly, embodiments of a write call sent from an application to the driver 100 may include a quantity of data greater than the packet size. In one embodiment, the packet size used is 1536 bytes, in accordance with typical Ethernet packets. In other embodiments, other packet sizes are used, generally ranging from 10 bytes to 100 kilobytes, more preferably from 1 kilobyte to 10 kilobytes, and still more preferably from 1 kilobyte to 5 kilobytes. In one embodiment the packet size in 9 kilobytes. In other embodiments, other packet sizes are used. The data sent in a write call to the socket 101 may be of any quantity, generally ranging from 1 byte to 1.28 Gigabytes, more preferably from 1 kilobyte to 64 kilobytes. In other embodiments, a larger amount of data is sent in a write call.

Embodiments of the present invention thus allow some or all data to bypass the packetization typically performed by the network protocol stack by modifying the NIC driver.

Embodiments of the invention further provide buffer management to support zero-copy writes from the application to the network driver. Briefly, the memory that an application uses in an operating system is called virtual memory. When the application issues a write( ) call, it points to data in the virtual memory. The operating system maps this virtual memory to physical memory and then sends the address of the physical memory where the data is to the NIC. The NIC retrieves this data from the memory using Direct Memory Access (DMA) and sends it over the network. The translation from virtual memory to physical memory is an expensive operation. In embodiments of the present invention, the application allocates translation buffers that are already setup with a translation from virtual to physical memory. The application uses these translation buffers when writing data to the network. Since the translation from virtual to physical memory is already available for these buffers the driver can efficiently queue this data to the NIC. This process is generally referred to herein as a zero-copy write.

Zero-copy writes enable the application to make data that is available in the computer memory pages to be made available to the network driver without requiring any intermediate copies. This reduces CPU usage requirements by the application, making more of the CPU available for data transmittal, thereby increasing the throughput through the system. Memory used to store the data in a write call is registered with the driver 100, and accordingly, no firmware changes are necessary if the memory is changed or relocated.

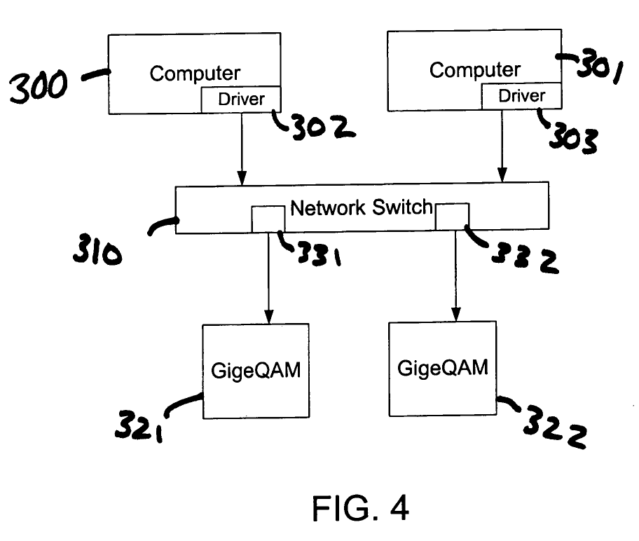

FIG. 4 depicts an embodiment of a system according to the present invention. Two computers, labeled 300 and 301, are in communication with a network switch 310. Although only two computers are shown in FIG. 4, it is to be understood that in accordance with embodiments of the invention any number of computers, including one computer, may be in communication with the network switch 310. The computers 300 and 301 are each provided with an embodiment of a driver, labeled 302 and 303, respectively, as described above. The network switch 310 functions to route packets received from the drivers 302 and 303 to other devices in communication with the switch 310. In the embodiment shown in FIG. 4, two client access devices (such as, for example, a DSLAM router that transmits data to the user's computer or set-top boxes or an Gigabit Ethernet QAM device that is used to modulate digital data to Radio Frequency that is suitable to be sent over a cable network), labeled 321 and 322 are in communication with the network switch 310. A GigeQAM generally takes data as UDP packets over a Gigabit Ethernet link and outputs the data using QAM modulation over an Radio Frequency network. In some embodiments, the input to a GigeQAM is MPEG-2 Transport Stream data over UDP packets. Each UDP packet shall contain 1-7 MPEG-2 Transport Stream packets, where each MPEG-2 Transport Stream packet is 188 bytes long. Each input to a GigeQAM is typically a Single Program MPEG-2 Transport Stream (SPTS). The output from a GigeQAM is a Multi Program MPEG-2 Transport Stream (MPTS). The multiplexed data is carried over an Radio Frequency network using modulation techniques called Quadrature Amplitude Modulation (QAM). The output frequency can range from 50 MHz to 850 MHz. It is to be understood that in other embodiments, any number of devices, and generally a variety of types of devices may be in communication with the network switch 310 and configured to receive packets from the network switch 310. The GigeQAMs 321 and 322 are configured to modulate packetized streams of data to radio frequencies suitable for transmission over a coaxial cable network to an end user device (such as a cable settop box or a personal computer). Communication between the computers 300 and 301 and the network switch 310 may be implemented in any manner known in the art—including electrical, optical, and wireless communication. Communication between the switch 310 and the devices 321 and 322 may also be implemented in any manner known in the art—including electrical, optical and wireless communication, in accordance with embodiments of the invention.

The network switch 310 receives packets from any number of computers, including computers 300 and 301 in FIG. 4. The packets may be destined for any number of destinations, including GigeQAMs 321 and 322 in FIG. 4. In typical systems, the application writing to a network stack has little or no control over how the data is sent to a network switch. In accordance with embodiments of the present invention, however, the drivers 302 and 303 allow the application to have some control over how the data is sent to the network switch. For example, in one embodiment an application sends a write call to the driver 302. The write call includes portions of the data to be sent to a first destination and portions of data to be sent to a second destination. The driver processes the data to form packets of a size less than or equal to a packet size, 1536 bytes in one embodiment. In one embodiment, one of the networked devices comprises a GigeQAM, the packet size is limited to 1316 (7*188 bytes). In the example shown in FIG. 4, two packets are generated to be sent to GigeQAM 321, and one packet is generated to be sent to GigeQAM 322. The driver 302 accordingly transmits a first packet destined for GigeQAM 321 to the switch 310, followed by the packet destined for GigeQAM 322, followed by the second packet destined for GigeQAM 321. In this manner, the driver 302 has aided in the load balancing on the network switch 310. In other embodiments, the particular order for sending packets to the switch 310 may be different, but the load balancing is still improved. For example, more than two destinations may be included, and the driver alternates sending packets between all destinations, and the like. In one embodiment, a plurality of packets are generated destined for each destination.

The network switch 310 has buffers 330 and 331, in some embodiments, for buffering data going to a downstream device, such as the downstream devices 321 and 322. Embodiments of the present invention reduce the requirements for the depth of this buffer because the drivers 302 and 303 are able to output packets in a predictable order to the switch 310.

As described above, a single write call may include data destined for a plurality of different destinations. Embodiments of the present invention utilize this feature to improve throughput from a NIC. Several streams of data are grouped into a single write call. An interval is selected and all data to be sent in that time interval is grouped into the write call. The length of the time interval is selected based on the bit rate of the stream and the amount of data from a single stream that would be transferred in the write call. For example, if the bit rate of the stream is 375000 bits per second (bps) and if the data is transferred to HPN in chunks of 21056 (16*1316, remember 1316 is the unit of data that downstream devices dealing with MPEG-2 such as GigeQAMs expect), then the interval chosen is less than or equal to 44.9 ms i.e. the streaming application needs to transfer 21056 bytes of data to HPN every 44.9 ms to maintain the bit rate. In one embodiment, the selected interval is 12 ms. In other embodiments, the interval may range from 1 to 100 ms, and in some embodiments a larger interval is used.

Another aspect where CPU cycles are spent during network communication is in processing interrupts from the network protocol stack. If the interrupt frequency is set too low, the throughput on the NIC decreases. If the interrupt frequency is set too high, the CPU wastes processing power receiving the interrupts. Conventional network protocol stacks, for example, as shown in FIG. 1, typically need to guess the optimal value for the interrupt generation depending on packet sizes seen. Embodiments of the present invention set the interrupt generation frequency to be generally as low as possible to avoid wasting CPU cycles. However, to avoid large delays sometimes associated with low interrupt generation frequency, the NIC is programmed to generate an interrupt only when the last packet for a write call is transmitted over the network, in some embodiments. This minimizes the delay seen by the application while improving the NIC's throughput.

Packets transmitted over a network may have several headers. For example, for UDP packets, the packets include a UDP header and an IP header. For streaming data using RealTime Protocol (RTP), the packet also contains an RTP header. Typically, each header is generated by a different level of the network protocol stack. Each header is then queued to the NIC individually, requiring several entries in the queue for one packet. Embodiments of the driver 100, shown in FIG. 2, generate a single header containing header information from a plurality of layers. The single header is sent to the NIC's queue, requiring only a single line for the header.

From the foregoing it will be appreciated that, although specific embodiments of the invention have been described herein for purposes of illustration, various modifications may be made without deviating from the spirit and scope of the invention. For example, although time-based, or real-time data and multimedia files have been discussed in embodiments of the invention, techniques described here are applicable for increasing the throughput for delivery of any type of data.

What is claimed is:

1. A method for reducing processor cycles required to send data over a communication link in packets having a packet size, the method comprising:
sending a write call comprising a destination and a quantity of data greater than said packet size to a driver through a socket;
performing a zero-copy write of said quantity of data to said driver; and
generating a plurality of packets less than or equal to said packet size.

2. A method according to claim 1, further comprising
grouping data from a plurality of streams into said write call.

3. A method according to claim 2, wherein said grouped data comprises all data from said plurality of streams to be sent in a time interval.

4. A method according to claim 3, wherein the time interval is selected based on a bit rate of at least one stream.

5. A method according to claim 1, wherein said zero-copy write comprises writing data to a translation buffer.

6. A method according to claim 5, wherein the translation buffer is setup with a translation between virtual memory and physical memory.

7. A method according to claim 1, further comprising generating an interrupt only after a last packet of said plurality of packets is transmitted to said communication link.

8. A method according to claim 1, wherein said packet size is a maximum packet size allowable by the communication link.

9. A method according to claim 1, wherein the communication link comprises a network.

10. A method according to claim 1, wherein said write call further comprises a plurality of destinations.

11. A method according to claim 1, wherein said quantity of data comprises at least a portion of a multimedia data file.

12. A method according to claim 11 wherein the multimedia data file requires real-time delivery.

13. A method according to claim 11, wherein the multimedia data file is a video file, an audio file, or a game file.

14. A method according to claim 1, wherein said quantity of data comprises at least a portion of a file having a format chosen from the group of formats consisting of MPEG-1, MPEG-2, MPEG-4, H.264, MP3, QuickTime, AVI, Audio/Video, real-time data in RTP format, and combinations thereof.

15. A method according to claim 1, further comprising:
communicating at least one of said packets to a network interface card.

16. A method according to claim 1, further comprising: storing said quantity of data in memory registered with said driver.

17. A method according to claim 1, wherein said write call comprises a write vector.

18. A method according to claim 1, further comprising generating a single header comprising header information for a plurality of protocol layers and sending the single header to a queue for a NIC.

19. A computer program product for sending data over a communications link in packets having a packet size, the computer program product comprising:
a computer-readable medium comprising a program module, the program module including instructions for:
receiving a write call comprising a destination and a quantity of data greater than said packet size through a socket;
performing a zero-copy write of said quantity of data; and
generating a plurality of packets less than or equal to said packet size.

20. A computer program product according to claim 19, further comprising instructions for:
grouping data from a plurality of streams into said write call.

21. A computer program product according to claim 20, wherein said grouped data comprises all data from said plurality of streams to be sent in a time interval.

22. A computer program product according to claim 21, wherein the time interval is selected based on a bit rate of at least one stream.

23. A computer program product according to claim 19, wherein said zero-copy write comprises writing data to a translation buffer.

24. A computer program product according to claim 23, wherein the translation buffer is setup with a translation between virtual memory and physical memory.

25. A computer program product according to claim 19, further comprising generating an interrupt only after a last packet of said plurality of packets is transmitted to said communication link.

26. A computer program product according to claim 19, wherein said packet size is a maximum packet size allowable by the communication link.

27. A computer program product according to claim 19, wherein said write call further comprises a plurality of destinations.

28. A computer program product according to claim 19, wherein said quantity of data comprises at least a portion of a multimedia data file.

29. A computer program product according to claim 28 wherein the multimedia data file requires real-time delivery.

30. A computer program product according to claim 28, wherein the multimedia data file is a video file, an audio file, or a game file.

31. A computer program product according to claim 19, wherein said quantity of data comprises at least a portion of a file having a format chosen from the group of formats consisting of MPEG-1, MPEG-2, MPEG-4, H.264, MP3, QuickTime, AVI, Audio/Video, real-time data in RTP format, and combinations thereof.

32. A computer program product according to claim 19, further comprising: communicating at least one of said packets to a network interface card.

33. A computer program product according to claim 19, further comprising: storing said quantity of data in memory.

34. A computer program product according to claim 19, wherein said write call comprises a write vector.

35. A method for reducing buffering requirements on a network switch; the method comprising:
receiving a write call from an application through a socket, the write call comprising a plurality of destinations, including a first destination and a second destination, and a first quantity of data destined for the first destination, and a second quantity of data destined for the second destination;
packetizing said first quantity of data into a plurality of packets less than or equal to a packet size, each packet destined for the first destination;
generating at least one packet comprising at least a portion of the second quantity of data destined for the second destination;
transmitting a first packet destined for the first destination to the network switch; and
transmitting the at least one packet destined for the second destination to the network switch, before transmitting a second packet destined for the first destination.

36. A method according to claim 35, wherein the first quantity of data comprises at least a portion of a video media file.

37. A method according to claim 35, further comprising generating a plurality of said packets comprising at least a portion of the second quantity of data destined for the second destination.

38. A method according to claim 35, further comprising:
transmitting the second packet destined for the first destination.

39. A method according to claim 35, wherein said write call further comprises a plurality of destinations.

40. A method according to claim 35, further comprising:
communicating at least one of said packets to a network interface card.

41. A method according to claim 35, further comprising:
performing a zero-copy write of said quantity of data.

42. A method according to claim 35, wherein said write call comprises a write vector.

43. A computer program product for balancing load on a network switch; the computer program product comprising:
a computer-readable medium comprising a program module, the program module including instructions for:
receiving a write call from an application through a socket, the write call comprising a plurality of destinations, including a first destination and a second destination, and a first quantity of data destined for the first destination, and a second quantity of data destined for the second destination;
packetizing said first quantity of data into a plurality of packets less than or equal to a packet size, each packet destined for the first destination;
generating at least one packet comprising at least a portion of the second quantity of data destined for the second destination;
transmitting a first packet destined for the first destination to the network switch; and
transmitting the at least one packet destined for the second destination to the network switch, before transmitting a second packet destined for the first destination.

44. A system for sending data across a network, the system comprising:
a computer running an application configured to send a write call to a driver through a socket, the write call comprising a destination and a quantity of data greater than a packet size, the application further configured to perform a zero-copy write of said quantity of data to said driver; the driver configured to packetize said data into a plurality of packets less than or equal to said packet size; and
a downstream device adapted to receive at least one of said packets.

45. A system according to claim 44, further comprising a network switch coupled to the computer and the downstream device, adapted to receive at least one of said packets and route the received packet to the downstream device.

46. A system according to claim 44, wherein the downstream device comprises a down stream device has a timing requirement for receipt of data.

47. A system according to claim 45, further comprising a plurality of said computers in communication with the network switch.

48. A system according to claim 44, further comprising a plurality of downstream devices in communication with the network switch.
